(19) United States
(12) Patent Application Publication
(10) Pub. No.: US 2025/0018445 A1
(43) Pub. Date: Jan. 16, 2025

(54) Cleaning System

(71) Applicant: Gate CFV Solutions, Inc., SEBASTIAN, FL (US)

(72) Inventors: GILLIAN CALLAGHAN, Vero Beach, FL (US); Dustin Hartsfield, SEBASTIAN, FL (US); Jacob Lockwood, Vero Beach, FL (US)

(21) Appl. No.: 18/772,195

(22) Filed: Jul. 14, 2024

Related U.S. Application Data
(60) Provisional application No. 63/527,002, filed on Jul. 15, 2023.

(51) Int. Cl. B08B 9/032; A47J 31/46; A47J 31/60; F16K 7/12; F16K 31/126

(52) U.S. Cl. CPC B08B 9/0325; A47J 31/461; A47J 31/60; F16K 7/12; F16K 31/1262; B08B 2209/032

(57) ABSTRACT

This disclosure relates to a cleaning system including: a CF Valve, the CF Valve coupled to a pressure source and a cleaning unit; the cleaning unit including a cleaning material bag and an outlet area, a cleaning solution recipe generated via the pressure source, the CF Valve, and the cleaning material bag; and a dispensing device coupled to the outlet area which receives a cleaning solution generated by the cleaning solution recipe.

### PRIORITY INFORMATION

The present application claims priority to Provisional Patent Application No. 63/527,002 filed Jul. 15, 2023, which is incorporated in its entirety by reference.

### BACKGROUND DISCUSSION

The dispensing industry is becoming more complex based on customer demand for customized drinks. These customized drinks require precision applications of various liquids and gases. In addition, material cost, labor cost, and labor safety are important factors that need to be enhanced. Further, customers demand a high level of cleaning to ensure that these customized drinks are safe. By utilizing this disclosure, the operator can achieve clean, customized, precision drinks with reduced material cost and labor cost while increase labor safety.

### BRIEF DESCRIPTION OF DRAWINGS

FIG. 1A is an embodiment of a cleaning system, according to one embodiment.

FIG. 1B is another embodiment of a cleaning system, according to one embodiment.

FIG. 1C is another embodiment of a cleaning system, according to one embodiment.

FIG. 1D is another embodiment of a cleaning system, according to one embodiment.

FIG. 2A is another embodiment of a cleaning system, according to one embodiment.

FIG. 2B is another embodiment of a cleaning system, according to one embodiment.

FIG. 2C is another embodiment of a cleaning system, according to one embodiment.

FIG. 2D are embodiments of cleaning recipes for various cleaning system, according to various embodiments.

FIG. 3A is another embodiment of a cleaning system, according to one embodiment.

FIG. 3B is another embodiment of a cleaning system, according to one embodiment.

FIG. 3C is another embodiment of a cleaning system, according to one embodiment.

FIG. 4A is an embodiment of a fitting device for a cleaning system, according to one embodiment.

FIG. 4B is another embodiment of a fitting device for a cleaning system, according to one embodiment.

FIG. 4C is another embodiment of a fitting device for a cleaning system, according to one embodiment.

FIG. 4D is another embodiment of a fitting device for a cleaning system, according to one embodiment.

FIG. 5A is another embodiment of a cleaning system, according to one embodiment.

FIG. 5B is another embodiment of a cleaning system, according to one embodiment.

FIG. 5C is an embodiment of a cleaning system block diagram, according to one embodiment.

FIG. 6A is an embodiment of a fitting device and an adaptor for a cleaning system, according to one embodiment.

FIG. 6B is another embodiment of a fitting device and an adaptor for a cleaning system, according to one embodiment.

FIG. 7A is an embodiment of a CF Valve, according to one embodiment.

FIG. 7B is another embodiment of a CF Valve, according to one embodiment.

FIG. 7C is another embodiment of a CF Valve, according to one embodiment.

### DETAILED DESCRIPTION

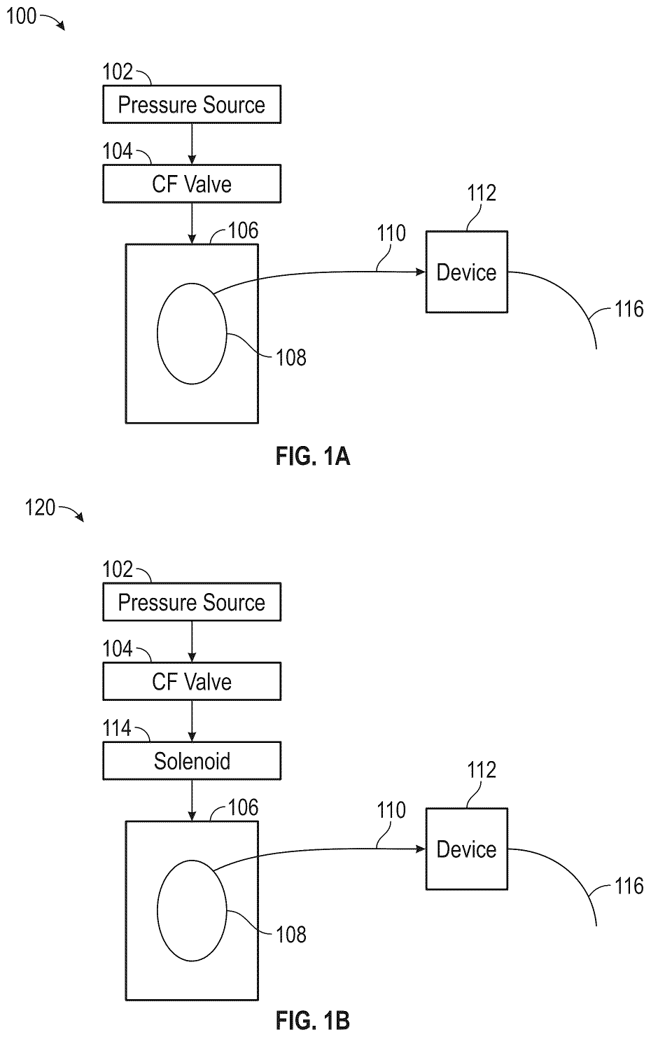

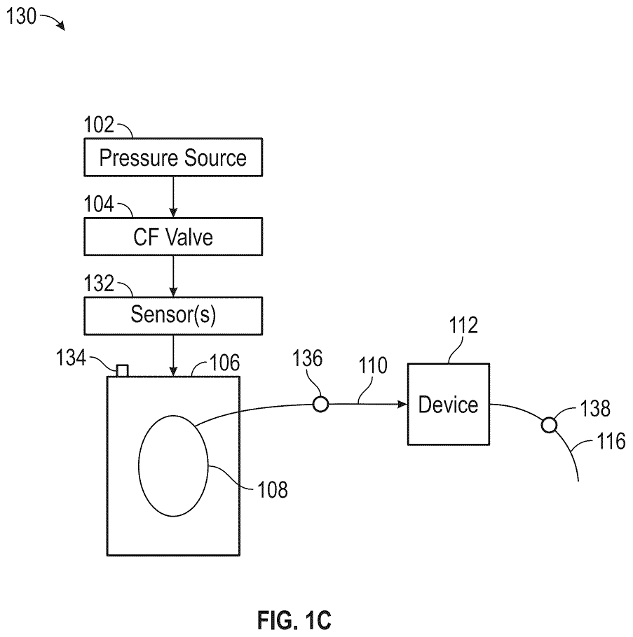

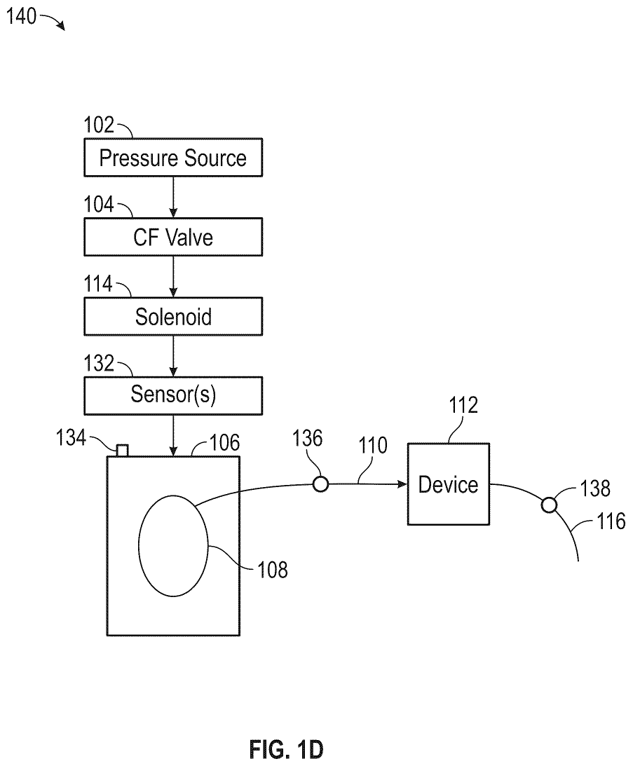

In FIGS. 1A-1D, illustrations of an exemplary embodiment of a cleaning system are shown, according to one embodiment. FIG. 1A shows a cleaning system 100, which includes a pressure source 102, a CF Valve 104, a container 106, a bag 108, a bag outlet line 110, a device 112, and a device outlet line 116. In this example, the CF Valve 104 is a non-electric CF Valve.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 106 of the input fluid (e.g., 7.5 PSI, 14PSI, 21PSI, 29PSI, etc.) where that pressure will then act on the flexible package 108 which contains the fluid (and/or cleaning element and/or ingredients (e.g., cleaner, sanitizer, etc.) and the fluid will be pushed through the flexible package 108 to the device 112 (and/or outlet).

The benefits of the cleaning system 100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 1B shows a cleaning system 120, which includes the pressure source 102, the CF Valve 104, the container 106, the bag 108, the bag outlet line 110, the device 112, the device outlet line 116 and a solenoid 114. In this example, the CF Valve 104 is an electric CF Valve.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 106 of the input fluid (e.g., 5.0 PSI, 10 PSI, 15 PSI, 20 PSI, etc.) where that pressure will then act on the flexible package 108 which contains the fluid (and/or cleaning element and/or ingredients (e.g., cleaner, sanitizer, etc.) and the fluid will be pushed through the flexible package 108 to the device 112 (and/or outlet).

The benefits of the cleaning system 100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 1C shows a cleaning system 130, which includes the pressure source 102, the CF Valve 104, the container 106, the bag 108, the bag outlet line 110, the device 112, the device outlet line 116, one or more sensors 132, a cleaning outlet line sensor 136, a device outlet line sensor 138, and a pressure relief device 134. In this example, the CF Valve 104 is a non-electric CF Valve.

In one example, the one or more sensors 132 may determine any characteristic of the pressure medium and based on the one or more determined medium characteristic modify any characteristic of the CF Valve 104, the bag 108, the bag outlet line 110, and/or any other system function and/or characteristic. In another example, the cleaning outlet line sensor 136 may determine any characteristic of the medium in the bag outlet line 110 and based on the one or more determined medium characteristic modify any characteristic of the CF Valve 104, the bag 108, the bag outlet line 110, and/or any other system function and/or characteristic. In another example, the device outlet line sensor 138 may determine any characteristic of the medium in the device outlet line 116 and based on the one or more determined medium characteristic modify any characteristic of the CF Valve 104, the bag 108, the bag outlet line 110, and/or any other system function and/or characteristic.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 106 of the input fluid (e.g., 3.0 PSI, 9.0 PSI, 13.0 PSI, 18.0 PSI, etc.) where that pressure will then act on the bag 108 which contains the fluid (and/or cleaning element and/or ingredients (e.g., cleaner, sanitizer, etc.) and the fluid will be pushed through the flexible package 108 to the device 112 (and/or outlet).

The benefits of the cleaning system 100 are that no pumps or plumbing or flow meters or connections are required to dispense any viscosity and/or any flow rate.

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

FIG. 1D shows a cleaning system 140, which includes the pressure source 102, the CF Valve 104, the container 106, the bag 108, the bag outlet line 110, the device 112, the device outlet line 116, one or more sensors 132, the cleaning outlet line sensor 136, the device outlet line sensor 138, the pressure relief device 134, and the solenoid 114. In this example, the CF Valve 104 is an electric CF Valve.

In one example, the one or more sensors 132 may determine any characteristic of the pressure medium and based on the one or more determined medium characteristic modify any characteristic of the CF Valve 104, the bag 108, the bag outlet line 110, and/or any other system function and/or characteristic. In another example, the cleaning outlet line sensor 136 may determine any characteristic of the medium in the bag outlet line 110 and based on the one or more determined medium characteristic modify any characteristic of the CF Valve 104, the bag 108, the bag outlet line 110, and/or any other system function and/or characteristic. In another example, the device outlet line sensor 138 may determine any characteristic of the medium in the device outlet line 116 and based on the one or more determined medium characteristic modify any characteristic of the CF Valve 104, the bag 108, the bag outlet line 110, and/or any other system function and/or characteristic.

In one example, the pressure in can be from city water, an air compressor, a pump, a compressed gas (e.g., CO₂ and/or Nitrogen), and/or any other available pressure source. In this example, when the input fluid passes through the CF Valve, the CF Valve creates a constant pressure into the pressure canister 106 of the input fluid (e.g., 10.0 PSI, 25.0 PSI, 45.0 PSI, 60.0 PSI, etc.) where that pressure will then act on the bag 108 which contains the fluid (and/or cleaning element and/or ingredients (e.g., cleaner, sanitizer, etc.) and the fluid will be pushed through the flexible package 108 to the device 112 (and/or outlet).

In another example, if the fluid viscosity is sensitive to temperature, a temperature sensor can be added to connect to the controllers of the equipment. If the temperature changes, the “on-time” of the CF Valves can be increased or decreased accordingly to account for the change in viscosity so that the same portion is dispensed to achieve a certain flow rate quantity to the point of cleaning.

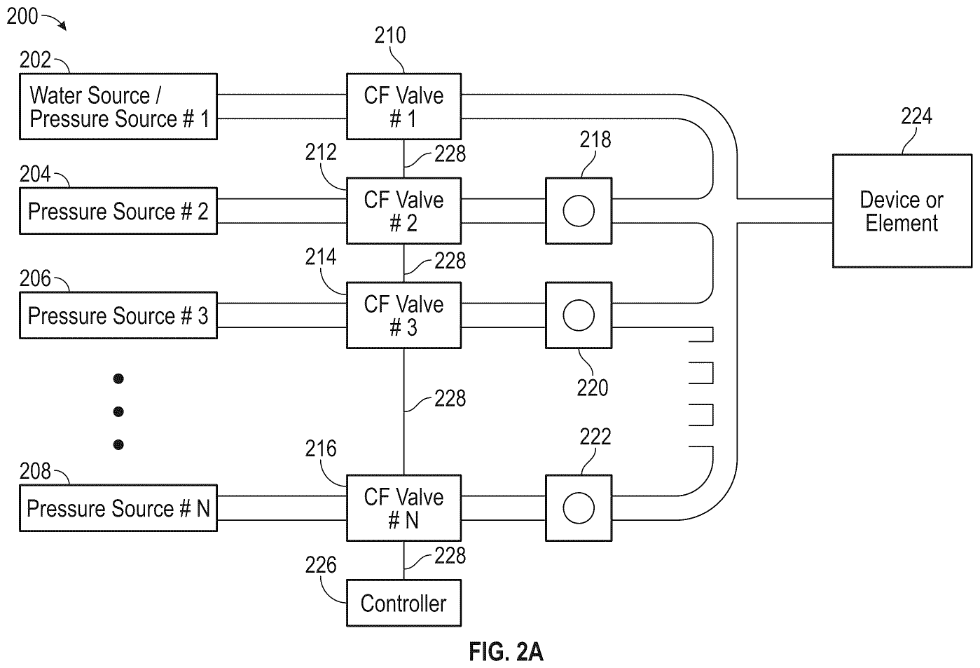

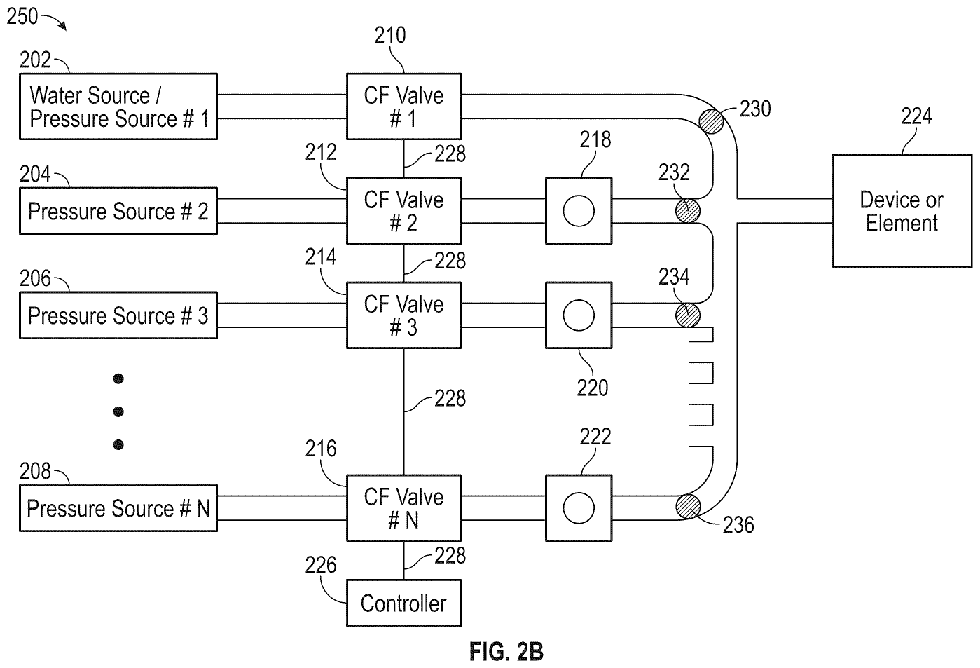

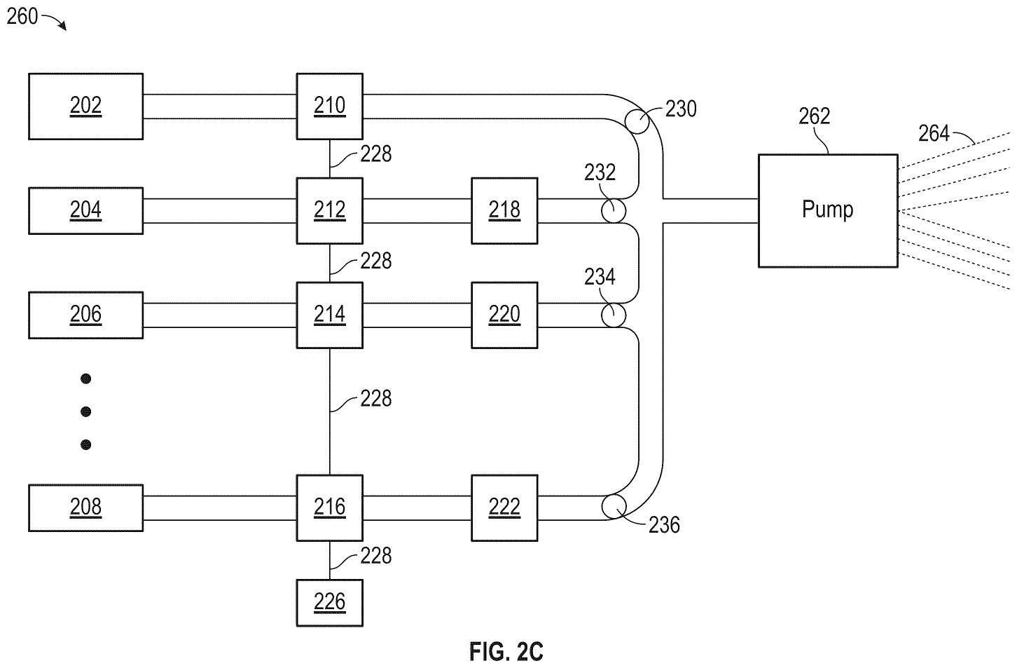

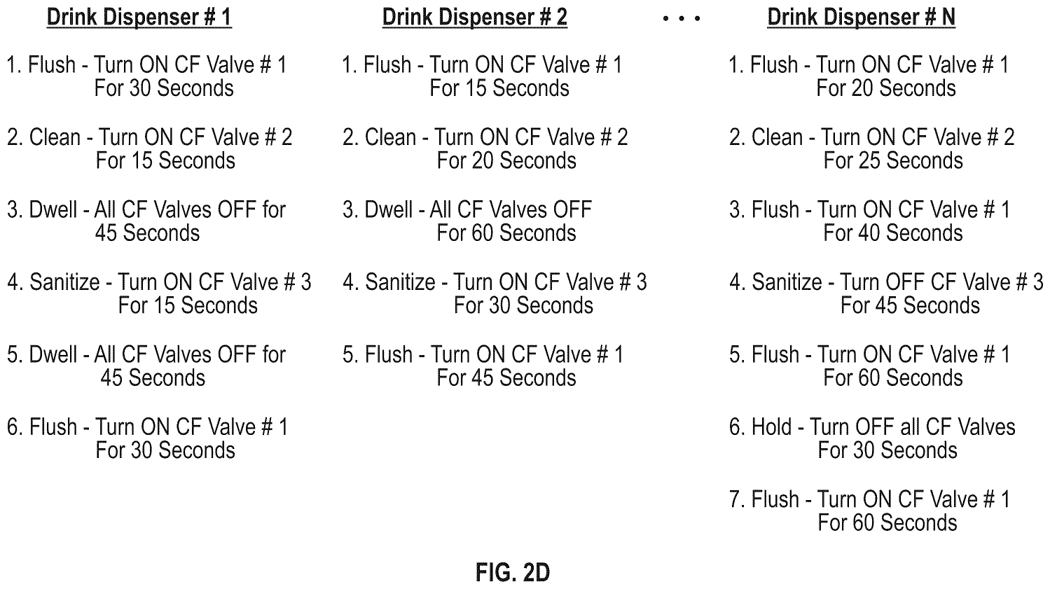

In FIG. 2A, a cleaning system 200 includes a water source 202 (and/or a first pressure source), a second pressure source 204, a third pressure source 206, an Nth pressure source 208, a first CF Valve 210, a second CF Valve 212, a third CF Valve 214, an Nth CF Valve 216, a first container with a bag 218, a second container with a bag 220, an Nth container with a bag 222, a device or element 224, a controller 226, and/or one or more control lines 228. In one example, the first container with a bag 218 has cleaning elements in the bag, the second container with a bag 220 has sanitizer elements in the bag, and the Nth container with a bag 220 has another element disclosed in this document.

In FIG. 2B, a cleaning system 250 includes the water source 202 (and/or the first pressure source), the second pressure source 204, the third pressure source 206, the Nth pressure source 208, the first CF Valve 210, the second CF Valve 212, the third CF Valve 214, the Nth CF Valve 216, the first container with a bag 218, the second container with a bag 220, the Nth container with a bag 222, the device or element 224, the controller 226, the one or more control lines 228, a first check valve 230, a second check valve 232, a third check valve 234, and/or an Nth check valve 236. In one example, the first container with a bag 218 has cleaning elements in the bag, the second container with a bag 220 has sanitizer elements in the bag, and the Nth container with a bag 220 has another element disclosed in this document.

In FIG. 2C, a cleaning system 260 includes the water source 202 (and/or the first pressure source), the second pressure source 204, the third pressure source 206, the Nth pressure source 208, the first CF Valve 210, the second CF Valve 212, the third CF Valve 214, the Nth CF Valve 216, the first container with a bag 218, the second container with a bag 220, the Nth container with a bag 222, the controller 226, the one or more control lines 228, the first check valve 230, the second check valve 232, the third check valve 234, the Nth check valve 236, a pump 262, and/or one or more lines 264 which lead to one or more devices and/or elements. In one example, the first container with a bag 218 has cleaning elements in the bag, the second container with a bag 220 has sanitizer elements in the bag, and the Nth container with a bag 220 has another element disclosed in this document.

FIG. 2D shows one or more cleaning recipes and/or procedures. In various embodiments, variables may be changed. For example, the time period, concentration of a cleaning element, sanitizer element, and/or any other element in this document, the order of operation, and/or any other characteristic may be modified and/or changed based on the targeting element to be cleaned and/or sanitized.

One of the benefits of this cleaning and/or sanitizing system is that any cleaner, or sanitizer, or cleaner/sanitizer can be utilizing in one or more canisters and then any number of chemicals and/or any amount of water (dilution) in any recipe to match any cleaning need. The same type of equipment could need different recipes depending on how it is used. For example, coffee machine that runs very oily beans gets cleaned with a higher concentration and more dwell times and more cycles of the cleaner. In another example, a coffee machine that runs not-oily can use a lower concentration and fewer cycles. In another example, a coffee machine can be cleaned daily or every 250 or 500 cups. So, a low volume store does not overuse chemicals. In another example, a drink machine that mixes concentrates with carbonated water or still water can also have a customized recipe based on what is being dispensed. For example, if a horchata drink tends to build up yeast or a dairy drink is more susceptible to bacteria then those can be on a more frequent and/or on a cycle that is longer has more cleaning steps and stronger concentrate. The same canister of XYZ cleaner or ABC Sanitizer of DEF Cleaner/Sanitizer can be used in any number of applications by customizing the recipe and the fluidics downstream.

In one embodiment shown in FIG. 2D, a first cleaning recipe is shown. The first cleaning recipe for drink dispenser number 1 may include: a first flush step (turn on CFValve #1 for 30 seconds); a first clean step (turn on CFValve #2 for 15 seconds); a first dwell step (turn on all CFValves off for 45 seconds); a first sanitize step (turn on CFValve #3 for 15 seconds); a second dwell step (turn all CFValves off for 45 seconds); and/or a second flush step (turn on CFValve #1 for 30 seconds).

In another embodiment shown in FIG. 2D, a second cleaning recipe is shown. The second cleaning recipe for drink dispenser number 2 may include: a first flush step (turn on CFValve #1 for 15 seconds); a first clean step (turn on CFValve #2 for 20 seconds); a first dwell step (turn on all CFValves off for 60 seconds); a first sanitize step (turn on CFValve #3 for 30 seconds); and/or a second flush step (turn on CFValve #1 for 45 seconds).

In an nth embodiment shown in FIG. 2D, an nth cleaning recipe is shown. The nth cleaning recipe for drink dispenser number N may include: a first flush step (turn on CFValve #1 for 20 seconds); a first clean step (turn on CFValve #2 for 25 seconds); a second flush step (turn on CFValve #1 for 40 seconds); a first sanitize step (turn on CFValve #3 for 45 seconds); a third flush step (turn on CFValve #1 for 60 seconds); a first hold step (turn off all CFValves for 30 seconds); and/or a fourth flush step (turn on CFValve #1 for 60 seconds).

In another embodiment shown in FIG. 2D, a cleaning recipe is shown. The cleaning recipe for drink dispenser may include: a first flush step (turn on CFValve #1 for 40 seconds); a first clean/sanitize step (turn on CFValve #2 for 35 seconds); a first dwell step (turn all CFValves off for 60 seconds); and/or a second flush step (turn on CFValve #1 for 90 seconds).

In another embodiment shown in FIG. 2D, a cleaning recipe is shown. The cleaning recipe for drink dispenser may include: a first flush step (turn on CFValve #1 for 50 seconds); a first/sanitize step (turn on CFValve #2 for 30 seconds); a first dwell step (turn all CFValves off for 120 seconds); and/or a second flush step (turn on CFValve #1 for 120 seconds).

In another embodiment shown in FIG. 2D, a cleaning recipe is shown. The cleaning recipe for drink dispenser may include: a first flush step (turn on CFValve #1 for 40 seconds); a first clean/sanitize step (turn on CFValve #2 for 35 seconds); and/or a first dwell step (turn all CFValves off for 60 seconds.

In another embodiment shown in FIG. 2D, a cleaning recipe is shown. The cleaning recipe for drink dispenser may include: a first clean step (turn on CFValve #2 for 50 seconds); a first dwell step (turn all CFValves off for 90 seconds); and/or a first flush step (turn on CFValve #1 for 30 seconds).

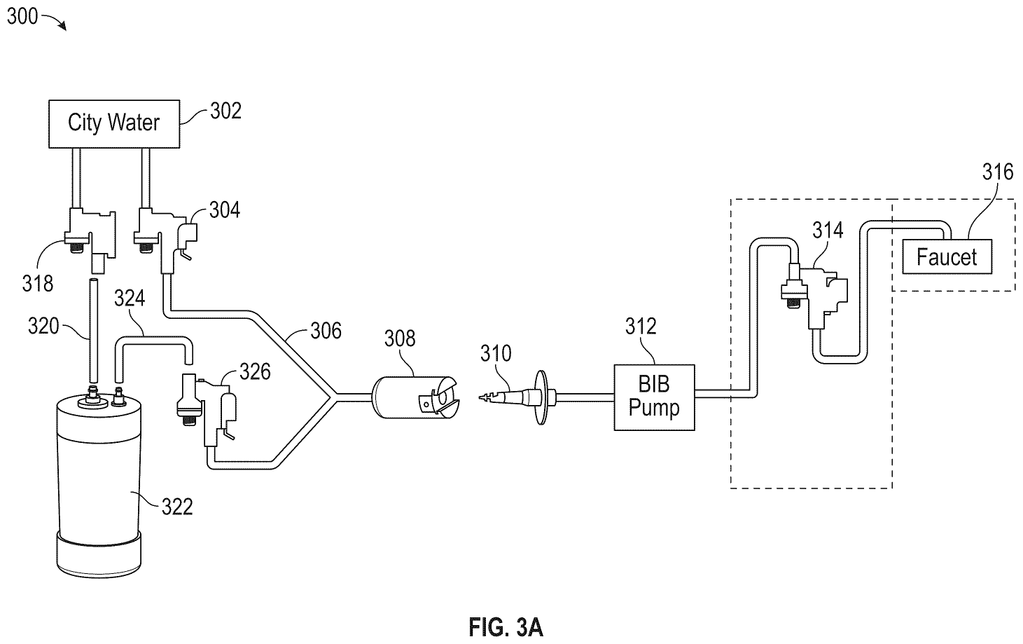

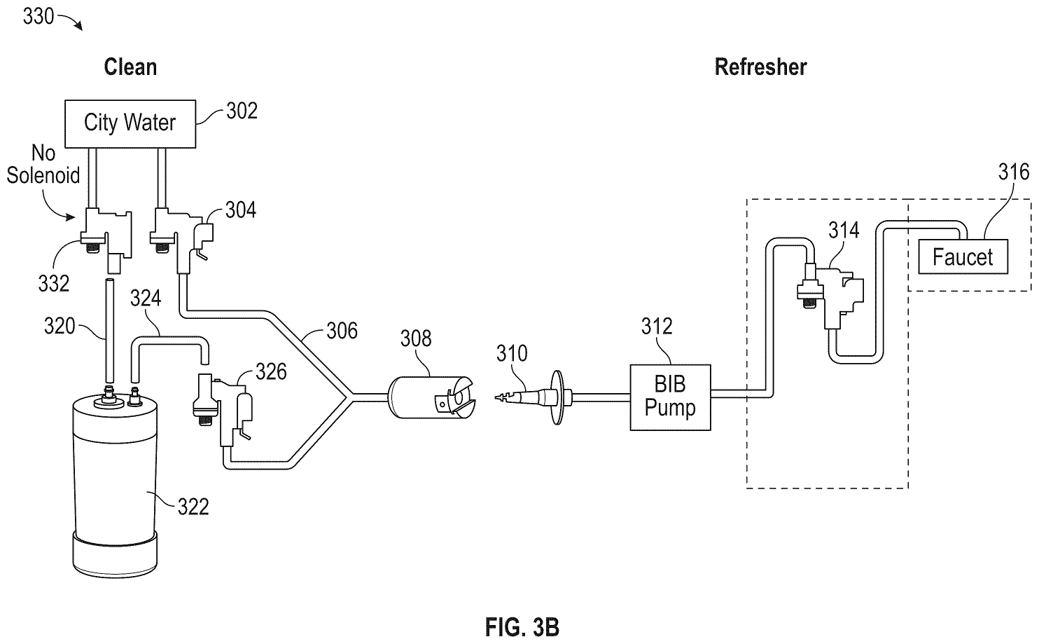

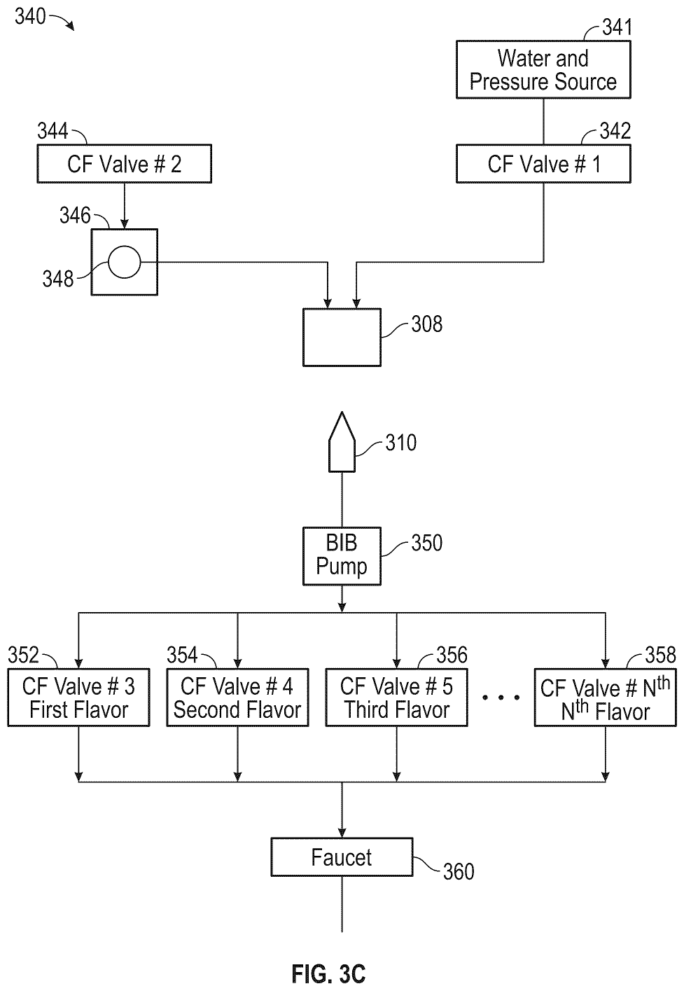

FIG. 3A shows a system 300 including a water source 302, an incoming water CF Valve 304 (e.g., electric), a water line 306, an adapter 308, a fitting 310, a bag-in-bottle device 312, an outlet CF Valve 314, a faucet 316, a second incoming water CF Valve (e.g., electric) 318, an inlet cleaning line 320, a cleaning container 322, an outlet cleaning line 324, and/or an outlet cleaning line CF Valve 326.

FIG. 3B shows a system 330 including the water source 302, the incoming water CF Valve 304 (e.g., electric), the water line 306, the adapter 308, the fitting 310, the bag-in-bottle device 312, the outlet CF Valve 314, the faucet 316, a second incoming water CF Valve (e.g., non-electric) 332, the inlet cleaning line 320, the cleaning container 332, the outlet cleaning line 324, and/or the outlet cleaning line CF Valve 326.

FIG. 3C shows a system 340 including a water/pressure source 341, a first CF Valve 342, a second CF Valve 344, a container 346, a bag 348 (with cleaning solution, sanitizer solution, or both), the adapter 308, the fitting 310, a bag-in-bottle device 350, a third CF Valve 352 (e.g., first flavor), a fourth CF Valve 354 (e.g., second flavor), a fifth CF Valve 356 (e.g., third flavor), an Nth CF Valve 358 (e.g., Nth flavor), and/or a faucet 360.

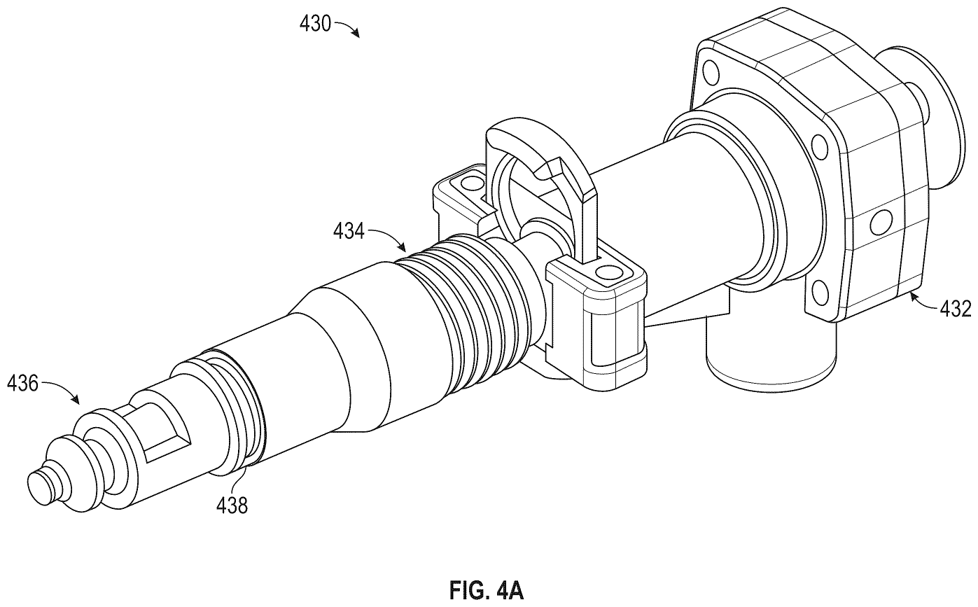

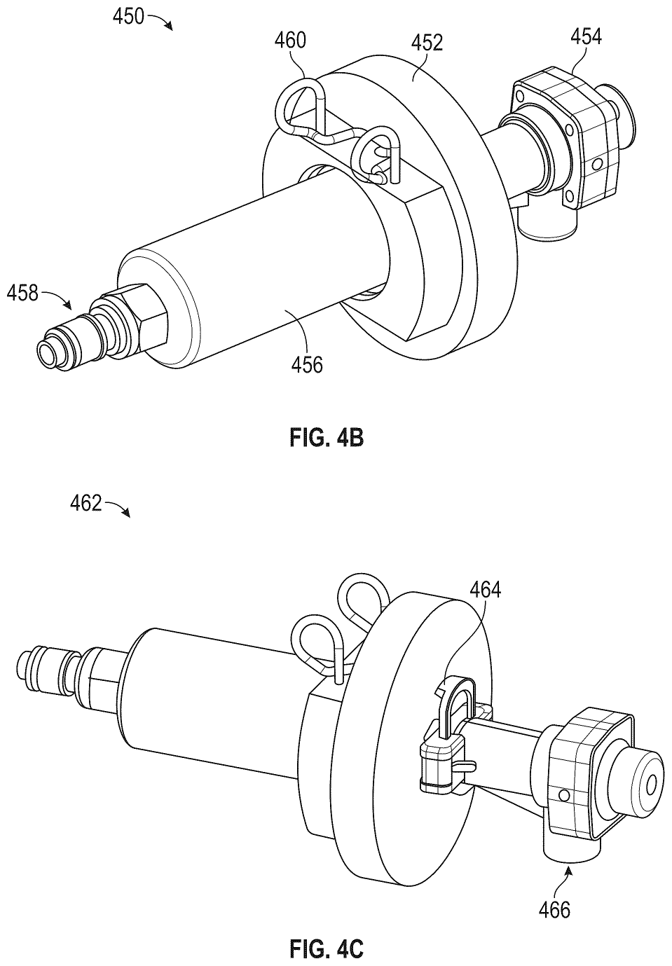

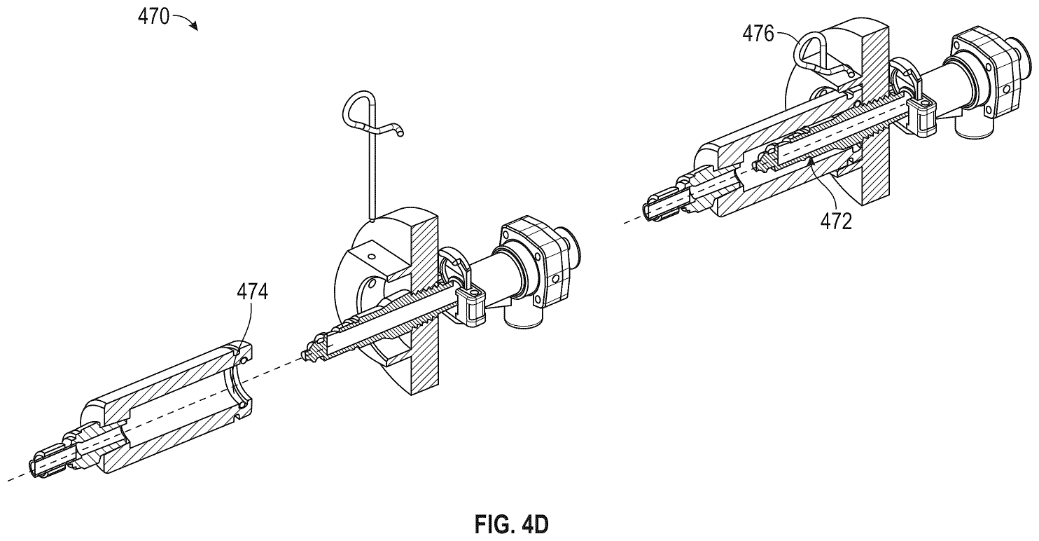

In FIGS. 4A-4D, illustrations of a fitting being utilized to connect the bag to the faucet are shown, according to various embodiments. In FIG. 4A, a fitting 430 includes an external end 432, a thread 434, an inside end 436, and/or an O-ring 438. In one example, the fitting 430 is a connection device between the ingredients bag 414 and the dispensing area 418. In this example, the fitting 430 connects with the ingredients bag 414 via the inside end 436 entering the ingredients bag 414. In addition, the fitting 430 connects with the dispensing area 418 via the external end 432.

In FIG. 4B, a fitting 450 includes a lid 452, a faucet 454, a cleaning fixture/sleeve 456, a dry break 458, and/or a retaining clip 460. In this example, the CFive on the faucet side and/or dispensing side may connect to the bag inside the pressurized vessel with a connection fitting 450. In this example, the fitting 450 connects the bag to dispensing area through the lid. In another example, the canister and/or lid can have an additional feature that holds the cap in the bag in place to make insertion of the connection directly into the bag consistent (e.g., no side loading).

In FIG. 4C, a fitting 462 includes a clip 464 and a faucet outlet 466. In this example, the cleaning fixture can be connected to the inside of the lid for a clean-in-place functionality. In addition, the fitting 462 will allow for cleaning and/or sanitizing fluid to clean the outside and inside of the fitting and to pass through the fitting and out the CF Valve by the faucet to clean all wetted surfaces. In FIG. 4D, a fitting 470 includes various internal elements 472, an O-ring 474, and/or a retaining clip 476. In one example, cleaning/sanitizing fluid cleans outside of probe fitting pas Cap/Bag O-ring seal (e.g., wetted surfaces). In another example, the O-ring in the sleeve seals to bottom of probe. In another example, the retaining clip keeps sleeve/fixture in place when pressurized.

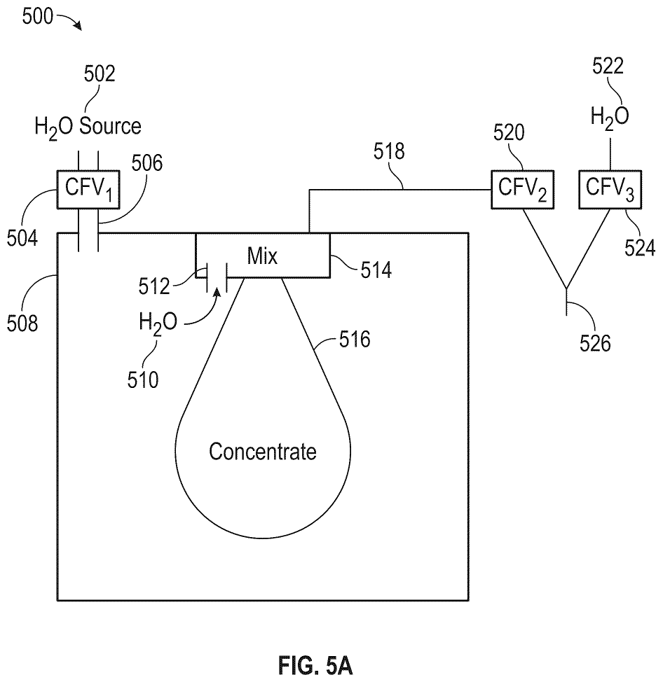

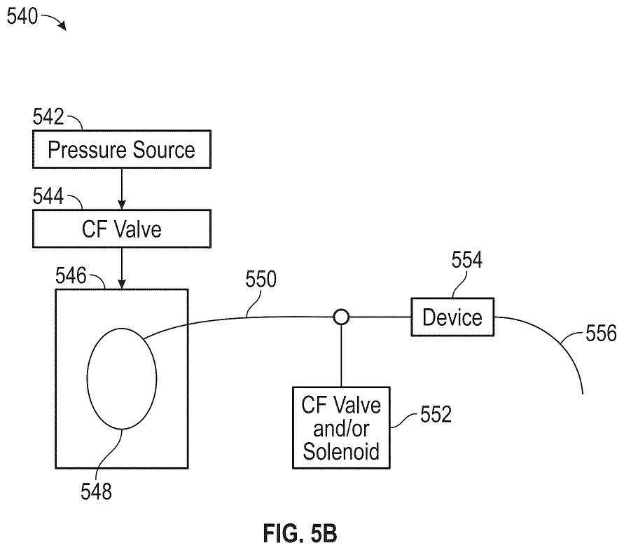

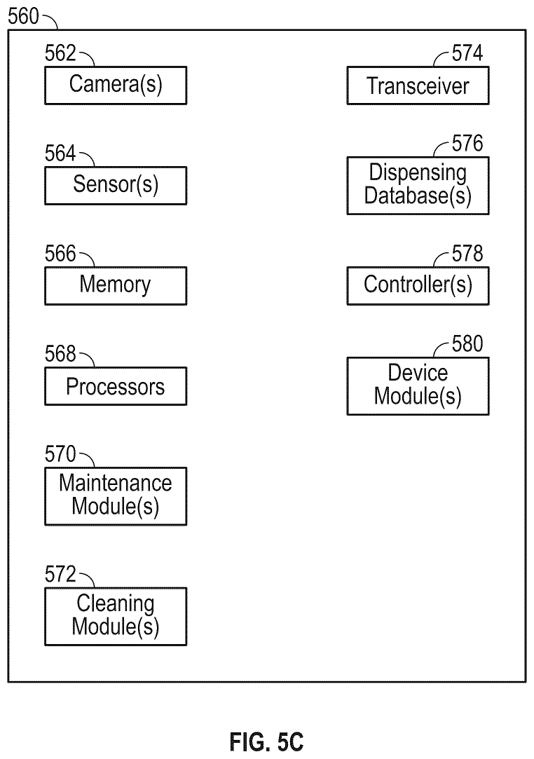

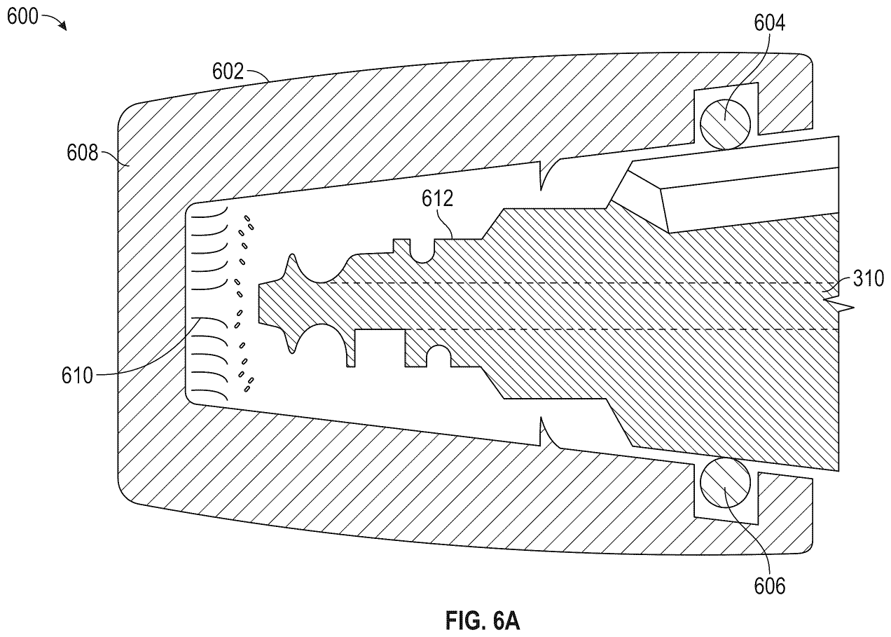

FIG. 5A shows a cleaning system 500 which includes a first H₂O source 502, a first CF Valve 504, a cleaning solution input area 506, a cleaning device 508, an inlet 510 to a mixing area 514, which allows water to enter the mixing area 514, a cleaning concentrate bag 516 where a non-diluted, pre-diluted, and/or full diluted cleaning concentrate enters the mixing area 514 to mix with the water from inlet 510, the non-diluted, pre-diluted, and/or full diluted cleaning concentrate leaves the cleaning device 508 via an exit line 518 to a second CF Valve, which obtains a final mixture ratio by being mixed with the second water source 522 and a third CF Valve 524 to obtain cleaning solution output 526.

In various examples shown in FIG. 2D, chemical compatibility, system material tolerances, Ph levels, drink materials, ratio requirements, and/or any other condition disclosed in this document, may be utilized to determine whether to non-dilute, pre-dilute, and/or fully dilute a cleaning system. For example, a 100 to 1 ratio; a 400 to 1 ratio; a 800 to 1 ratio; and/or a 1000 to 1 ratio may be utilized. In one example for coffee, a 100 to 1 ratio for the cleaning solution may be utilized.

FIG. 5B shows a cleaning system 540, which includes a pressure source 542, a first CF Valve 544, a container 546, a bag 548, a bag outlet line 550, a second CF Valve and/or a first solenoid 552, a device 554, and a device outlet line 556. In this example, the CF Valves 544 and 552 may be non-electric CF Valves and/or electric CF Valves.

FIG. 5C shows a block diagram 560 which includes a camera(s) 562, sensor(s) 564, memory 566, processor(s) 568, a maintenance module(s) 570, cleaning module(s) 572, a transceiver 574, a dispensing database(s) 576, controller(s) 578, and/or device module(s) 580.

In one example, a maintenance module 570 for a first dispensing system may include every drinking dispensing data (e.g., number of drinks, ratio, last maintenance cycle, temperature data, time of use data, etc.) for one or more dispensing devices.

In another example, a cleaning module 572 may include different cleaning recipes for a dispensing device based on the dispensing device usage since the last cleaning cycle. For example, a large amount of high viscosity drinks since the last cleaning cycle may indicate that a higher concentrate cleaning solution, recipe, and/or procedure should be utilized. This information may be included for a plurality of dispensing devices in the dispensing database 576. Further, the controller 578 may control one or more devices (CFValves, solenoids, check valves, etc.) to implement one or more cleaning recipes.

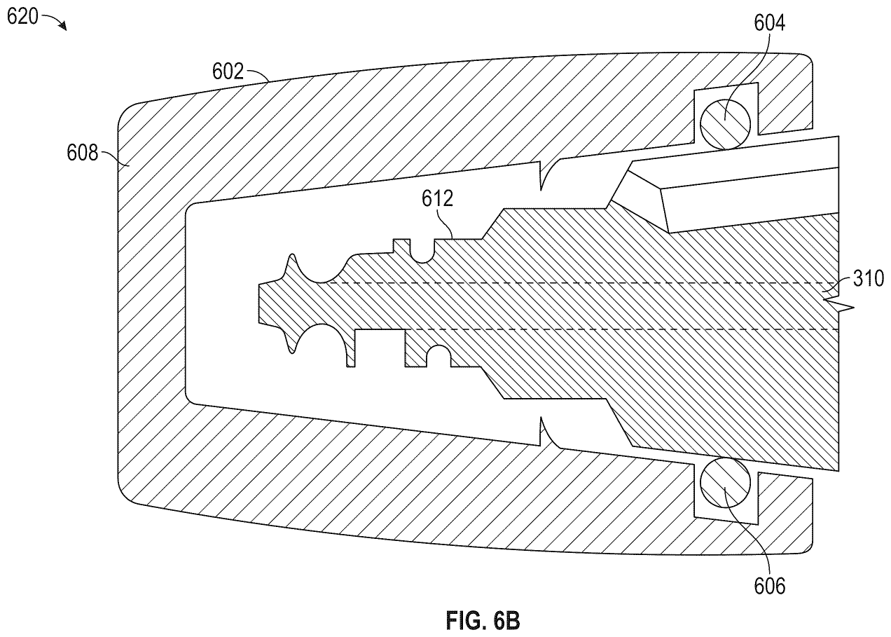

FIG. 6A shows the fitting device 310 and the adapter 602 connected for the cleaning and/or sanitizing operation. In this example, the adapter 602 has an inlet area 604, an outlet area 606, one or more walls 608, and a cleaning element area 610. In this example, water enters via the inlet area 604 and combines with the cleaning element area 610 to create a cleaning solution (and/or sanitizer solution). In this example, the adapter 602 may contain enough cleaning elements in cleaning element area 610 for a single use, two uses, three uses, etc. However, in a preferred embodiment, the adapter 602 is a single use device. In addition, one or more fitting areas 612 would not be cleaned during a cleaning operation that did not include the adapter 602.

FIG. 6B shows the fitting device 310 and the adapter 602 connected from the cleaning and/or sanitizing operation. In this example, there is no cleaning element area 610. Therefore, the cleaning and/or sanitizer would enter the inlet area 604 to clean and/or sanitize the fitting 310 and/or the one or more fitting areas 612

The dispensing system and/or dispensing devices can be utilized with OJ, juices, dairy products, soft drinks, coffee, beer, wine, seltzer, and/or any components thereof (e.g., hops, alcohol, pulp, cream, flavors, syrups, etc.).

This disclosure relates generally to fluid valves, and is concerned in particular with a regulating valve that is normally closed, that is opened by a variable fluid pressure above a selected threshold level, and that when open, serves to deliver the fluid at a constant pressure and flow rate.

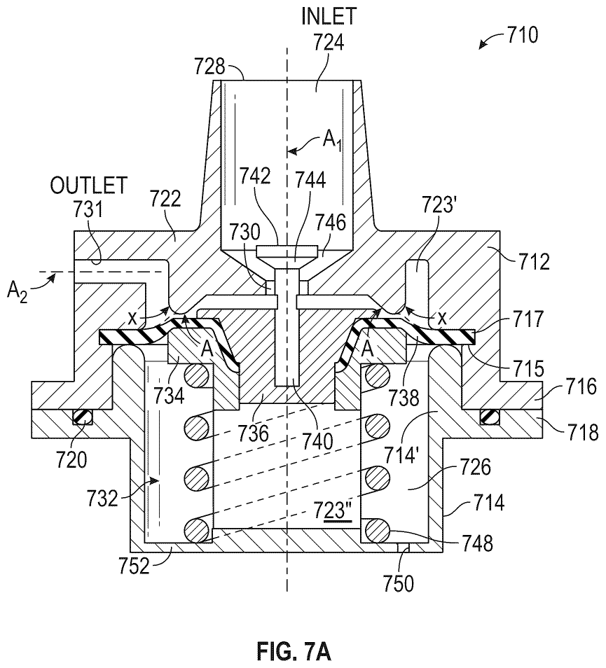

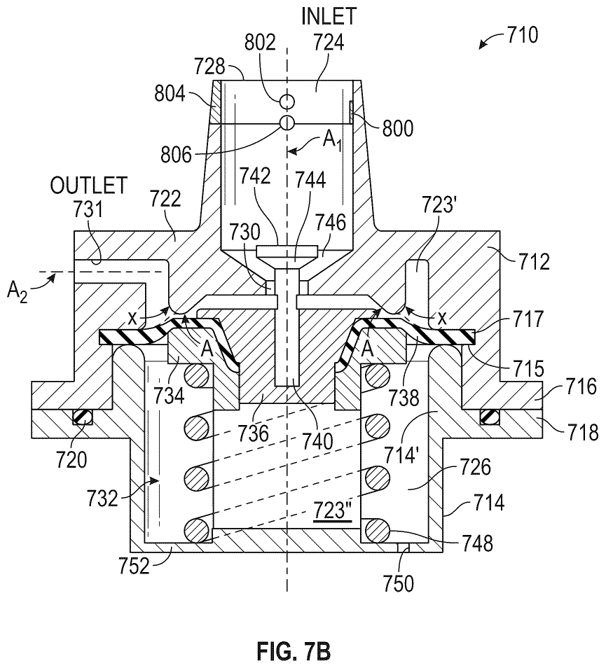

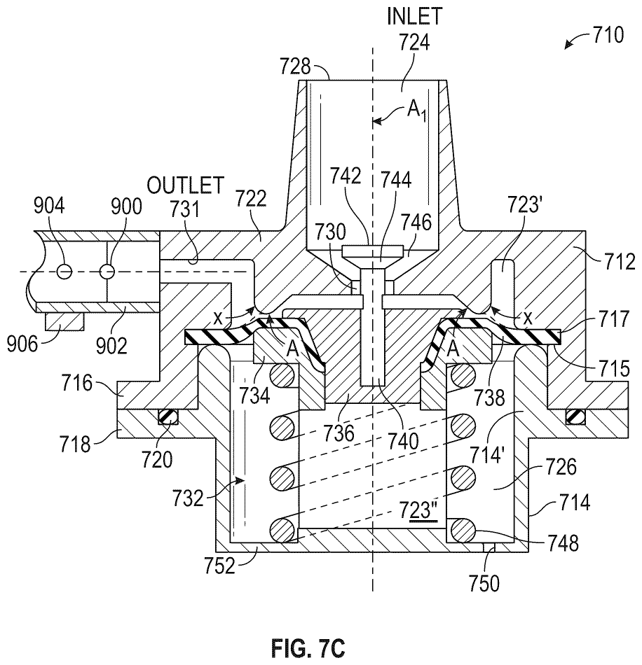

The drawing in FIG. 7A is a sectional view through a regulating valve in accordance with the present disclosure, the valve being shown is in its open condition.

With reference to the drawing, a regulating valve in accordance with the present disclosure is generally depicted at 710. The valve includes an outer housing having a cap 712 joined to a cup-shaped base 714 at mating exterior flanges 716, 718, with an O-ring seal 720 interposed there between.

The housing is internally subdivided by a barrier wall 722 into a head section 724 and a base section 726. An inlet 728 in the cap 712 is adapted to be connected to a fluid supply (not shown) having a pressure that can vary from below to above a threshold level. The inlet 728 and a central port 730 in the barrier wall 722 are aligned along a central axis A1 of the valve. An outlet port 731, also in the cap 712, is aligned on a second axis A2 transverse to the first axis A1.

A modulating assembly 732 cooperates with the barrier wall 722 to subdivide the base section into a fluid chamber 731 segregated from a spring chamber 723″. The modulating assembly serves to prevent fluid flow through the valve when the fluid pressure at the inlet 728 is below the threshold pressure.

When the fluid pressure at the inlet exceeds the threshold pressure, the modulating assembly serves to accommodate fluid flow from the head section 724 through port 730 into chamber 723′ at a constant pressure and flow rate, and from there through outlet port 731. Either the outlet port 731 or a downstream orifice or flow restrictor (not shown) serves to develop a back pressure in fluid chamber 723′.

The modulating assembly 732 includes a piston comprised of a hollow shell 734 and a central plug 736. The piston is supported for movement in opposite directions along axis A1 by a flexible annular diaphragm 738. The inner periphery of the diaphragm is captured between the shell 734 and plug 736. The cup shaped base 714 has a cylindrical wall segment 714′ received within the cap 712. The outer periphery of the diaphragm is captured between an upper rim 715 of the wall segment 714′ and an inwardly projecting interior ledge 717 on the cap.

A stem 740 on the piston plug 736 projects through the port 730 into the head section 724. An enlarged head 742 on the stem has a tapered underside 744 that coacts with a tapered surface 746 of the barrier wall to modulate the size of the flow path through the port 730 as an inverse function of the varying fluid pressure in the input section, with the result being to deliver fluid to the outlet 731 at a constant pressure and flow rate.

A compression spring 748 in the spring chamber 723″ is captured between an underside surface of shell 734 and the bottom wall 752 of the housing base 714. The spring urges the modulating assembly 732 towards the barrier wall 722. When the fluid pressure at the inlet 728 is below the threshold pressure, spring 748 serves to urge the diaphragm 738 against the barrier wall 722, thus preventing fluid flow from the fluid chamber 723′ to the outlet 731′. As the fluid pressure exceeds the threshold pressure, the resilient closure force of spring 748 is overcome, allowing the piston assembly to move away from the barrier wall, and allowing the modulating function of the coacting tapered surfaces 744, 746 to commence. An opening 750 in the bottom wall 752 serves to vent the volume beneath diaphragm 738 to the surrounding atmosphere.

In one example, a regulating valve for receiving fluid at a variable pressure from a fluid source and for delivering the fluid at a substantially constant pressure and flow rate to a fluid applicator or the like, the valve including: a cup-shaped base having a cylindrical wall segment terminating in an upper rim, and an externally projecting first flange; a cap having an inwardly projecting ledge and an externally projecting second flange, the cup-shaped base and the cap being configured and dimensioned for assembly as a unitary housing, with the cylindrical wall segment of the cup-shaped base inserted into the cap, and with the extent of such insertion being limited by the abutment of the first flange with the second flange to thereby provide a space between the upper rim of the cup-shaped base and the inwardly projecting ledge of the cap; a barrier wall subdividing the interior of the housing into a head section and a base section; a modulating assembly subdividing the base section into a fluid chamber and a spring chamber; an inlet in the cap for connecting the head section to the fluid source; a port in the barrier wall connecting the head section to the fluid chamber, the port being aligned with a central first axis of the valve; an outlet in the cap communicating with the fluid chamber, the outlet being aligned on a second axis transverse to the first axis; a stem projecting from the modulating assembly along the first axis through the port into the head section; a flexible diaphragm supporting the modulating assembly within the housing for movement in opposite directions along the first axis, the diaphragm having an outer periphery captured in the space between the inwardly projecting ledge of the cap and a rim of the cylindrical wall segment of the cup-shaped base; a spring in the spring chamber, the spring being arranged to resiliently urge the modulating assembly into a closed position at which the diaphragm is in sealing contact with the barrier wall to thereby prevent fluid flow from the head section via the port and fluid chamber to the outlet, the spring acting in concert with the modulating assembly and the stem projecting therefrom to modulate the size of the port as an inverse function of the variable fluid pressure in the input sections whereby the pressure and flow rate of the fluid delivered to the outlet is maintained substantially constant, the valve being automatically actuated when the pressure of the fluid acting on the modulating assembly exceeds a threshold level, and being automatically closed when the pressure drops below the threshold level.

In FIG. 7B, a magnetically activated ball valve device 800 has been added to regulating valve 710 where the magnetically activated ball valve device 800 is located in a position relative to the inlet (e.g., incoming fluid). In this example, the magnetically activated ball valve device 800 includes an opening 806, a ball 802, and a magnetic device 804. Additional embodiments of the magnetically activated ball valve device 800 and the functionality of the magnetically activated ball valve device 800 are shown in other figures of this disclosure. In other embodiments, the ball valve device 800 may be activated by the fluid flow, mechanical functionality (e.g., levers, etc.), magnetic functionality, and/or any combination of movement devices.

In FIG. 7C, a magnetically activated ball valve device 902 has been added to regulating valve 728 where the magnetically activated ball valve device 902 is located in a position relative to the outlet (e.g., outgoing fluid). In this example, the magnetically activated ball valve device 902 includes an opening 900, a ball 904, and a magnetic device 906. Additional embodiments of the magnetically activated ball valve device 902 and the functionality of the magnetically activated ball valve device 902 are shown in the other figures of this disclosure.

In one embodiment, a cleaning system may include: a CF Valve, the CF Valve coupled to a pressure source and a cleaning unit; the cleaning unit including a cleaning material bag and an outlet area, a cleaning solution recipe generated via the pressure source, the CF Valve, and the cleaning material bag; and a dispensing device coupled to the outlet area which receives a cleaning solution generated by the cleaning solution recipe.

In addition, the cleaning system may include: a dispensing device outlet area; a solenoid coupled to the CF Valve and the cleaning unit; a solenoid coupled to the CF Valve and the cleaning unit and one or more sensors; and/or one or more sensors. Further, a first sensor is configured to measure temperature data. In addition, the cleaning solution recipe is modified based on the measured temperature data. In addition, the CF Valve may include a housing having axially aligned inlet and outlet ports adapted to be connected respectively to the variable fluid supply and the fluid outlet; a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

Further, the CF Valve may maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice.

In another example, the CF Valve may maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

In another embodiment, a cleaning system may include: a first CF Valve configured to be utilized with a flush function; a second CF Valve configured to be utilized with a clean function; a third CF Valve configured to be utilized with a dwell function; a fourth CF Valve configured to be utilized with a sanitize function; and a controller configured to initiate one or more cleaning recipes.

In various examples, the controller may initiate a first cleaning recipe including a first flush function, a clean function, a first dwell function, a sanitize function, a second dwell function, and a second flush function. In addition, the controller may initiate a second cleaning recipe including a first flush function, a clean function, a dwell function, a sanitize function, and a second flush function. Further, the controller may initiate a third cleaning recipe including a first flush function, a clean function, a second flush function, a sanitize function, a third flush function, a hold function, and a fourth flush function. In another example, the controller may initiate a fourth cleaning recipe including a first flush function, a clean function, a dwell function, and a second flush function. In addition, the controller may initiate a fifth cleaning recipe including a first flush function, a sanitize function, a dwell function, and a second flush function. Further, the controller may initiate a sixth cleaning recipe including a clean function, a dwell function, and a flush function. In another example, the controller may initiate a seventh cleaning recipe including a flush function, a clean function, and a dwell function.

A constant flow regulating valve includes a closure mechanism configured and arranged to override the modulating mode of the valve and to close the valve at fluid inlet pressures both below and above the valve's threshold level. The closure mechanism may be selectively deactivated to thereby allow the valve to assume its normal pressure responsive regulating functions. Embodiments of the regulating valve incorporate pressure relief devices and vent seals, with configurations suitable for incorporation into the trigger assemblies of portable sprayers.

This disclosure relates generally to fluid valves, and is concerned in particular with a regulating valve that operates in response to a variable fluid inlet pressure above a selected threshold level to deliver the fluid at a constant outlet pressure and flow rate. A closure mechanism is selectively operable either to accommodate the valve's normal pressure responsive regulating functions, or to override such functions by maintaining the valve in a closed state at inlet pressures both above and below the threshold level.

In one example, valves are normally closed in response to fluid inlet pressures below a threshold level, and operate in a modulating mode in response to variable fluid inlet pressures above the threshold level to deliver fluids at constant outlet pressures and flow rates. However, at fluid inlet pressures above the threshold level, such valves remain open and cannot serve as shut off valves, thus making it necessary to employ additional and separately operable valves to achieve this added function.

In accordance with one aspect of the present disclosure, the known regulating valves are modified to include closure mechanisms configured and arranged to override the modulating mode of the valves and to maintain closure of the valves at fluid inlet pressures both below and above the threshold level. The closure mechanisms may be selectively deactivated to thereby allow the valves to assume their normal pressure responsive regulating functions.

In accordance with still another aspect of the present disclosure, the vent opening communicating with the valve's spring chamber is provided with a seal which allows air to escape and enter the spring chamber, but which prevents the escape of liquid from the spring chamber in the event that the valve diaphragm is breached.

In accordance with another aspect of the present disclosure, a pressure relief mechanism is provided for relieving residual fluid inlet pressure below the threshold level when the valve is closed.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. Any combination of any element in this disclosure with any other element in this disclosure is hereby disclosed. For example, an element on pages 2-3 can be combined with any element in this document (e.g., an element from pages 8-9).

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. A cleaning system comprising:
a CF Valve, the CF Valve coupled to a pressure source and a cleaning unit;
the cleaning unit including a cleaning material bag and an outlet area, a cleaning solution recipe generated via the pressure source, the CF Valve, and the cleaning material bag; and
a dispensing device coupled to the outlet area which receives a cleaning solution generated by the cleaning solution recipe.

2. The cleaning system of claim 1, further a dispensing device outlet area.

3. The cleaning system of claim 1, further comprising a solenoid coupled to the CF Valve and the cleaning unit.

4. The cleaning system of claim 1, further comprising one or more sensors.

5. The cleaning system of claim 4, wherein a first sensor is configured to measure temperature data.

6. The cleaning system of claim 1, wherein the cleaning solution recipe is modified based on the measured temperature data.

7. The cleaning system of claim 1, further comprising a solenoid coupled to the CF Valve and the cleaning unit and one or more sensors.

8. The cleaning system of claim 1, wherein the CF Valve includes a housing having axially aligned inlet and outlet ports adapted to be connected respectively to the variable fluid supply and the fluid outlet; a diaphragm chamber interposed between the inlet and the outlet ports, the inlet port being separated from the diaphragm chamber by a barrier wall, the barrier wall having a first passageway extending therethrough from an inner side facing the diaphragm chamber to an outer side facing the inlet port; a cup contained within the diaphragm chamber, the cup having a cylindrical side wall extending from a bottom wall facing the outlet port to a circular rim surrounding an open mouth facing the inner side of the barrier wall, the cylindrical side and bottom walls of the cup being spaced inwardly from adjacent interior surfaces of the housing to define a second passageway connecting the diaphragm chamber to the outlet port; a resilient disc-shaped diaphragm closing the open mouth of the cup, the diaphragm being axially supported by the circular rim and having a peripheral flange overlapping the cylindrical side wall; a piston assembly secured to the center of the diaphragm, the piston assembly having a cap on one side of the diaphragm facing the inner side of the barrier wall, and a base suspended from the opposite side of the diaphragm and projecting into the interior of the cup; a stem projecting from the cap through the first passageway in the barrier wall to terminate in a valve head, the valve head and the outer side of the barrier wall being configured to define a control orifice connecting the inlet port to the diaphragm chamber via the first passageway; and a spring device in the cup coacting with the base of the piston assembly for resiliently urging the diaphragm into a closed position against the inner side of the barrier wall to thereby prevent fluid flow from the inlet port via the first passageway into the diaphragm chamber, the spring device being responsive to fluid pressure above a predetermined level applied to the diaphragm via the inlet port and the first passageway by accommodating movement of the diaphragm away from the inner side of the barrier wall, with the valve head on the stem being moved to adjust the size of the control orifice, thereby maintaining a constant flow of fluid from the inlet port through the first and second passageways to the outlet port for delivery to the fluid outlet.

9. The cleaning system of claim 1, wherein the CF Valve is configured to maintain a relative constant flow of fluid from a variable pressure fluid supply to a fluid outlet, the CF Valve including: a) a valve housing having an inlet port and an outlet port adapted to be connected to the variable pressure fluid supply and the fluid outlet; b) a diaphragm chamber interposed between the inlet port and the outlet port; c) a cup contained within the diaphragm chamber; d) a diaphragm closing the cup; e) a piston assembly secured to a center of the diaphragm, the piston assembly having a cap and a base; f) a stem projecting from the cap through a first passageway in a barrier wall to terminate in a valve head; and g) a spring in the cup coacting with the base of the piston assembly for urging the diaphragm into a closed position, and the spring being responsive to fluid pressure above a predetermined level to adjust a size of a control orifice.

10. The cleaning system of claim 1, wherein the CF Valve is configured to maintain a relative constant flow of fluid from a variable pressure fluid supply to a fluid outlet, the CF Valve including: a base having a wall segment terminating in an upper rim, and a projecting first flange; a cap having a projecting ledge and a projecting second flange, the wall segment of the base being located inside the cap with a space between the upper rim of the base and the projecting ledge of the cap; a barrier wall subdividing an interior of a housing into a head section and a base section; a modulating assembly subdividing the base section into a fluid chamber and a spring chamber; an inlet in the cap for connecting the head section to a fluid source; a port in the barrier wall connecting the head section to the fluid chamber, the port being aligned with a central first axis of the CF Valve; an outlet in the cap communicating with the fluid chamber, the outlet being aligned on a second axis transverse to the first axis; a stem projecting from the modulating assembly along the first axis through the port into the head section; a diaphragm supporting the modulating assembly within the housing for movement in opposite directions along the first axis, a spring in the spring chamber, the spring being arranged to urge the modulating assembly into a closed position at which the diaphragm is in sealing contact with the barrier wall, and the spring being responsive to fluid pressure above a predetermined level to adjust a size of a control orifice.

11. A cleaning system comprising:
a first CF Valve configured to be utilized with a flush function;
a second CF Valve configured to be utilized with a clean function;
a third CF Valve configured to be utilized with a dwell function;
a fourth CF Valve configured to be utilized with a sanitize function; and
a controller configured to initiate one or more cleaning recipes.

12. The cleaning system of claim 11, wherein the controller is configured to initiate a first cleaning recipe including a first flush function, a clean function, a first dwell function, a sanitize function, a second dwell function, and a second flush function.

13. The cleaning system of claim 11, wherein the controller is configured to initiate a second cleaning recipe including a first flush function, a clean function, a dwell function, a sanitize function, and a second flush function.

14. The cleaning system of claim 11, wherein the controller is configured to initiate a third cleaning recipe including a first flush function, a clean function, a second flush function, a sanitize function, a third flush function, a hold function, and a fourth flush function.

15. The cleaning system of claim 11, wherein the controller is configured to initiate a fourth cleaning recipe including a first flush function, a clean function, a dwell function, and a second flush function.

16. The cleaning system of claim 11, wherein the controller is configured to initiate a fifth cleaning recipe including a first flush function, a sanitize function, a dwell function, and a second flush function.

17. The cleaning system of claim 11, wherein the controller is configured to initiate a sixth cleaning recipe including a clean function, a dwell function, and a flush function.

18. The cleaning system of claim 11, wherein the controller is configured to initiate a seventh cleaning recipe including a flush function, a clean function, and a dwell function.
